(19) United States
(12) Patent Application Publication
(10) Pub. No.: US 2011/0145714 A1
(43) Pub. Date: Jun. 16, 2011

(54) SYSTEM AND METHOD FOR WEB-INTEGRATED STATISTICAL ANALYSIS

(75) Inventors: Erian Laperi, Wentzville, MO (US); Robert Mark Clark, Crestwood, MO (US); James D. Cunliffe, II, Belleville, MI (US); Richard K. Hartenberger, Houston, TX (US); Mo Katibeh, Richardson, TX (US); John Lampros, St. Louis, MO (US); Joel Palmer, Florissant, MO (US)

(73) Assignee: AT&T INTELLECTUAL PROPERTY I, L.P., Reno, NV (US)

(21) Appl. No.: 12/638,785

(22) Filed: Dec. 15, 2009

(51) Int. Cl. G06F 3/00

(52) U.S. Cl. 715/738

(57) ABSTRACT

A method and system for performing statistical analysis using a web browser includes selecting raw data for statistical analysis and specifying statistical operation(s) on the raw data. The web browser may be used to generate first program code corresponding to the statistical operation(s). After sending the first program code to a web server for execution, output data resulting from executing the first program code may be received at the web browser. The web browser may generate and display a graphical representation of the output data. The web browser may also be used to configure the graphical representation and generate second program code executable by a web browser for generating the graphical representation.

### BACKGROUND

1. Field of the Disclosure

The present disclosure relates to statistical analysis and, more particularly, to web-integrated statistical analysis.

2. Description of the Related Art

Statistical analysis is often performed using specialized hardware and/or software components. Many enterprises desire to perform complex statistical analyses using existing infrastructure, including commonly used software components.

### BRIEF DESCRIPTION OF THE DRAWINGS

FIG. 1 is a block diagram of selected elements of an embodiment of a enterprise data processing system;

FIG. 2 is a block diagram of selected elements of an embodiment of an enterprise network system;

FIG. 3 is a block diagram of selected elements of an embodiment of a network server system;

FIG. 4 illustrates selected elements of an embodiment of a user interface for statistical analysis;

FIG. 5 illustrates selected elements of an embodiment of a user interface for statistical analysis;

FIG. 6 illustrates selected elements of an embodiment of a user interface for statistical analysis;

FIG. 7 illustrates an embodiment of a method for performing statistical analysis; and

FIG. 8 illustrates an embodiment of a method for performing statistical analysis.

### DESCRIPTION OF THE EXEMPLARY EMBODIMENTS

In one aspect, a disclosed method for providing statistical analysis at a web browser includes selecting, using the web browser, raw data comprising a plurality of data values and associated range values. The method may further include specifying, using the web browser, a statistical operation, and causing, using the web browser, the statistical operation to be performed on the raw data. The method may also include receiving, at the web browser, output data resulting from the statistical operations, while the output data are usable to generate a graphical representation of a result of the statistical operation. The method operation of causing the statistical operation to be performed may further include sending first program code corresponding to the statistical operations to a network server. In certain embodiments, the native primary key may include a compound primary key. The network server may access the raw data via an enterprise database.

In particular embodiments, the method may further include displaying the graphical representation using the web browser. The method may further include using the web browser to configure the graphical representation, including formatting and labeling of data values and associated range values of the graphical representation. The method may still further include using the web browser to generate second program code corresponding to the graphical representation. The second program code may be executable by the web browser to display the graphical representation. The method may yet further include making the second program code accessible using the web browser. The second program code may be hypertext markup language (HTML) code.

In yet another aspect, a computer system for performing statistical analysis at a web browser includes a processor configured to access a memory medium. The memory medium may include instructions executable by the processor to use the web browser to select raw data comprising a plurality of data values and associated range values, and use the web browser to specify a statistical operation on the raw data. The memory medium may further include instructions executable by the processor to use the web browser to generate first program code corresponding to the statistical operation, including a reference to the raw data, and use the web browser to send the first program code to a web server. The memory medium may also include instructions executable by the processor to receive, at the web browser, output data resulting from the first program code. The output data may be usable to generate a graphical representation of a result of the statistical operation.

In some embodiments, the memory medium may further include instructions executable by the processor to execute the web browser, and instruct the web server to execute the first program code. The memory medium may further include instructions executable by the processor to use the web browser to display the graphical representation.

In selected embodiments, the memory media may further include processor instructions executable to use the web browser to configure the graphical representation, including receiving user input for formatting and labeling of data values and associated range values of the graphical representation. The memory medium may further include instructions executable by the processor to use the web browser to generate second program code corresponding to the graphical representation. The second program code may be executable by the web browser to display the graphical representation. The second program code may be HTML code.

In yet another aspect, disclosed computer-readable memory media include instructions for performing statistical analysis at a web browser. The instructions may be executable to use the web browser to select raw data comprising a plurality of data values and associated range values, and use the web browser to specify a statistical operation on the raw data. The memory media may further include instructions executable to use the web browser to generate first program code corresponding to the statistical operation, including a reference to the raw data, and use the web browser to send the first program code to a web server. The memory media may still further include instructions executable to receive, at the web browser, output data resulting from the first program code. The output data may be usable to generate a graphical representation of a result of the statistical operation.

In given embodiments, the memory media may further include instructions executable to execute the web browser, and instruct the web server to execute the first program code. The memory media may further include instructions executable to use the web browser to display the graphical representation. The memory media may yet further include instructions executable to use the web browser to configure the graphical representation, including receiving user input for formatting and labeling of data values and associated range values of the graphical representation.

In certain embodiments, the memory media may further include instructions executable to use the web browser to generate second program code corresponding to the configured graphical representation. The second program code may be HTML code executable by the web browser to display the graphical representation. The memory media may also include instructions executable to use the web browser to output the second program code. The memory media may still further include instructions executable to send the second executable code to the web server for distribution to other web browsers.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

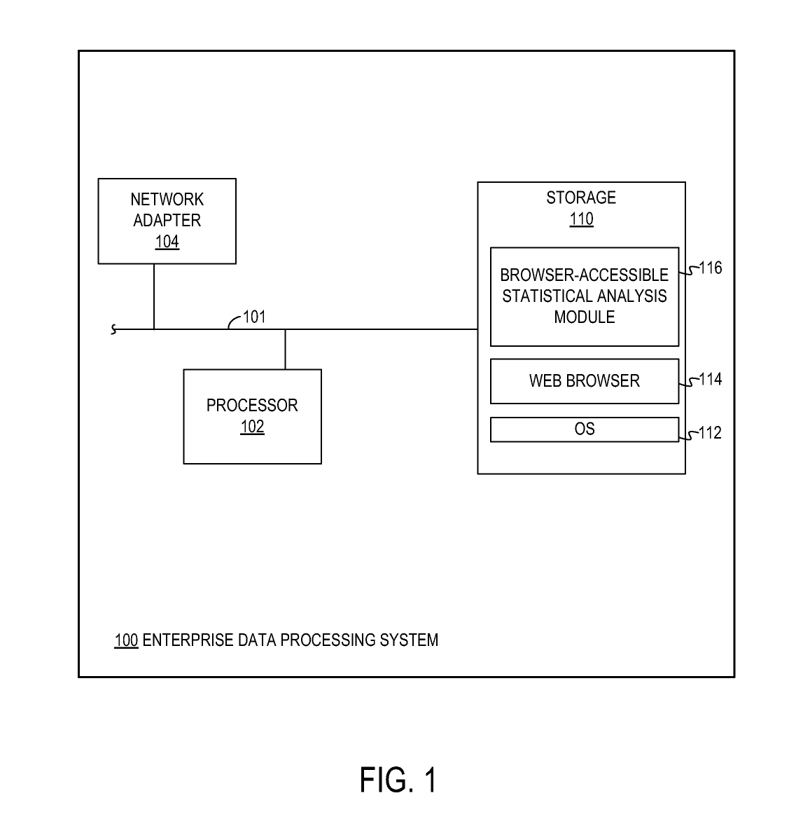

Turning now to the drawings, FIG. 1 a block diagram illustrating selected elements of an embodiment of enterprise data processing system 100 is presented. In FIG. 1, enterprise data processing system 100 is shown as a functional component independent of any physical implementation. In particular, it is noted that enterprise data processing system 100 may include additional components or elements (not shown in FIG. 1) commonly used with data processing systems, such as peripheral devices, storage devices, multimedia devices, and display devices, among others.

In the embodiment depicted in FIG. 1, enterprise data processing system 100 includes processor 102 coupled via shared bus 101 to storage media collectively identified as storage 110. Enterprise data processing system 100, as depicted in FIG. 1, further includes network adapter 104 that may interface enterprise data processing system 100 to various components of a network (not shown in FIG. 1).

Storage 110 encompasses persistent and volatile media, fixed and removable media, and magnetic and semiconductor media. Storage 110 is operable to store instructions, data, or both. Storage 110 as shown may include sets or sequences of instructions, namely, operating system 112, web browser 114, and browser-accessible statistical analysis module 116. Operating system 112 may be a UNIX or UNIX-like operating system, a Windows® family operating system, or another suitable operating system. Web browser 114 may be any program that provides for interactive web browsing, including retrieving, presenting, and traversing information resources on the World Wide Web, and may also be used to access information provided by Web servers in private networks or files in file systems. An information resource is identified by a Uniform Resource Identifier (URI) and may be a web page, image, video, or other piece of content. Web browser 114 may support HTML commands. Browser-accessible statistical analysis module 116 may provide functionality to implement statistical analysis using web browser 114, as will be described in detail below.

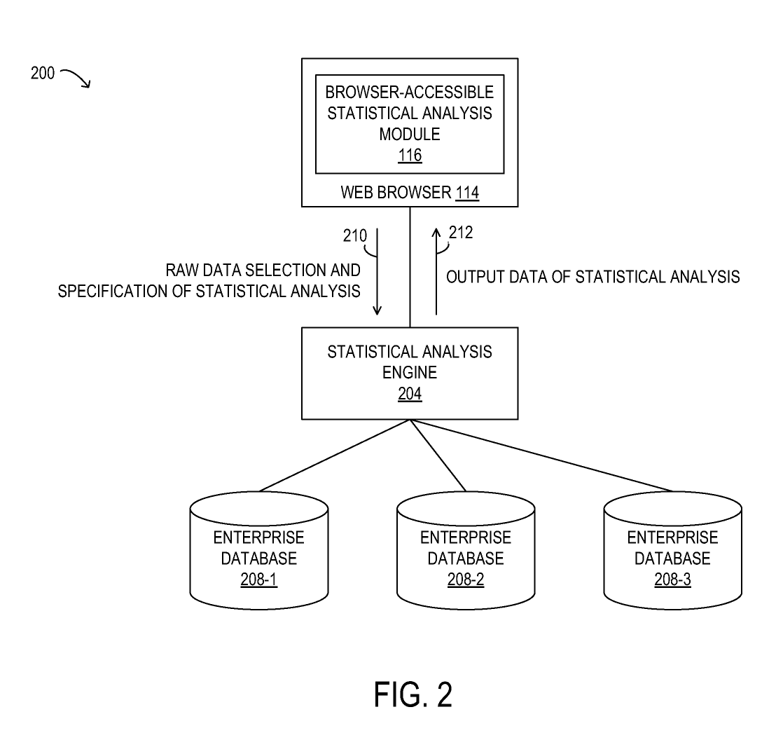

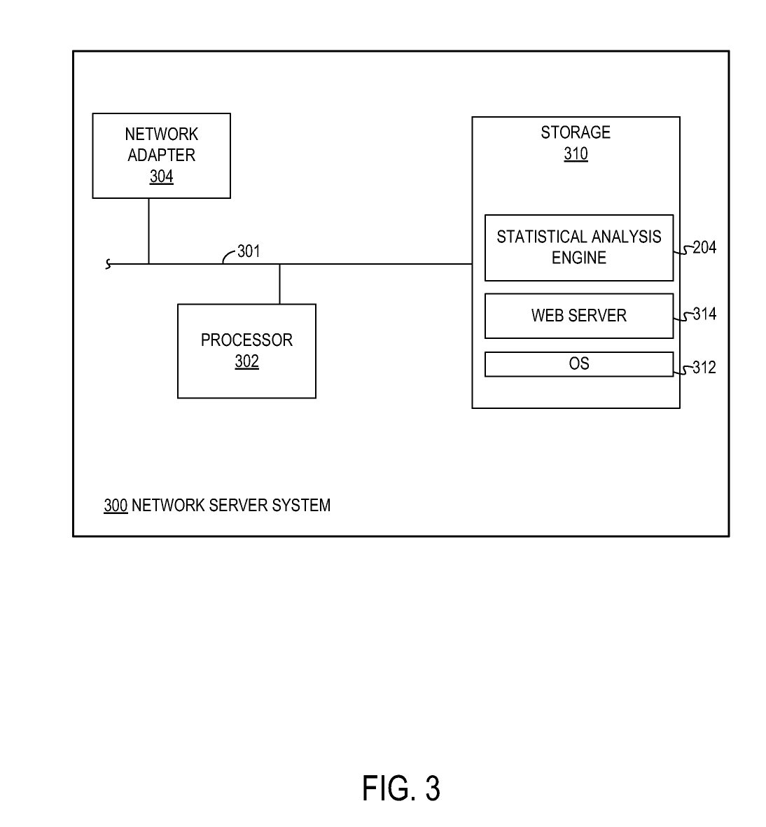

Turning now to FIG. 2, a block diagram of selected elements of an embodiment of enterprise network system 200 is depicted. Enterprise network system 200 may comprise a number of network servers and network client systems, which are represented by functional elements in FIG. 2. Web browser 114 may represent one of a multitude of network clients (or web clients), executing from respective enterprise data processing systems (such as enterprise data processing system 100 in FIG. 1) in enterprise network system 200. Web browser 114 is shown in enterprise network system 200 including browser-accessible statistical analysis module 116, which may be a plug-in to web browser 114. Statistical analysis engine 204 may represent functionality provided at a representative enterprise server system (such as network server system 300 in FIG. 3). Enterprise databases 208 may represent enterprise database server systems accessible to statistical analysis engine 204.

In operation of enterprise network system 200, browser-accessible statistical analysis module 116 may be executed or invoked by web browser 114, and may augment functionality provided by web browser 114. Using web browser 114 in conjunction with browser-accessible statistical analysis module 116, user input may be received for selecting raw data for a statistical operation, such as a statistical analysis. The raw data may include at least one series of data values and associated range values, such as timestamps, categories, identities, sub-ranges, etc. User input for specifying the statistical analysis may also be received in the form of program code or a series of program instructions, including references to the raw data. The program code specifying the statistical analysis may include a number of different operators and operands, as desired. The statistical analysis may include querying of raw data from any one or more of enterprise databases 208-1, 208-2, and 208-3. Web browser 114 may then send to statistical analysis engine 204 information indicative of a raw data selection and a specification of a statistical analysis, represented in FIG. 2 by arrow 210. Statistical analysis engine 204 may receive the information and execute the statistical analysis as specified, including querying enterprise databases 208, and thereby generate output data of the statistical analysis. Statistical analysis engine 204 may then return the output data of the statistical analysis to web browser 114, represented in FIG. 2 by arrow 212. It is noted that arrows 210 and 212 may represent a transactional form of processing that may be repeated over several iterations for a given statistical operation or a statistical analysis. In certain embodiments, the operations performed by statistical analysis engine 204 may include intermediate operations that generate intermediate output data that may be stored on a network server system or on enterprise databases 208.

Turning now to FIG. 3, a block diagram illustrating selected elements of an embodiment of network server system 300 is presented. In FIG. 3, network server system 300 is shown as a functional component independent of any physical or virtual implementation. In particular, it is noted that network server system 300 may include additional components or elements (not shown in FIG. 3) commonly used with data processing systems, such as peripheral devices, storage devices, multimedia devices, and display devices, among others.

In the embodiment depicted in FIG. 3, network server system 300 includes processor 302 coupled via shared bus 301 to storage media collectively identified as storage 310. Network server system 300, as depicted in FIG. 3, further includes network adapter 304 that may interface network server system 300 to various components of a network (not shown in FIG. 3).

Storage 310 encompasses persistent and volatile media, fixed and removable media, and magnetic and semiconductor media. Storage 310 is operable to store instructions, data, or both. Storage 310 as shown may include sets or sequences of instructions, namely, operating system 312, web server 314, and statistical analysis engine 204. Operating system 312 may be a UNIX or UNIX-like operating system, a Windows® family operating system, or another suitable operating system. In some embodiments, storage 310 is configured to store and execute instructions provided as services to components in an enterprise network system (see also FIG. 2). Web server 314 may be any program that delivers (i.e., serves) content, using the Hypertext Transfer Protocol (HTTP). The term web server may also refer in general to network server system 300. Web server 314 may support HTML commands to deliver web pages (i.e., HTML documents) and associated content (e.g., images, style sheets, and/or plug-ins) to web clients, which are commonly web browsers. A web browser may send a request to web server 314 for a specific resource using HTTP and, in response, web server 314 may send content associated with the requested resource back to the web browser.

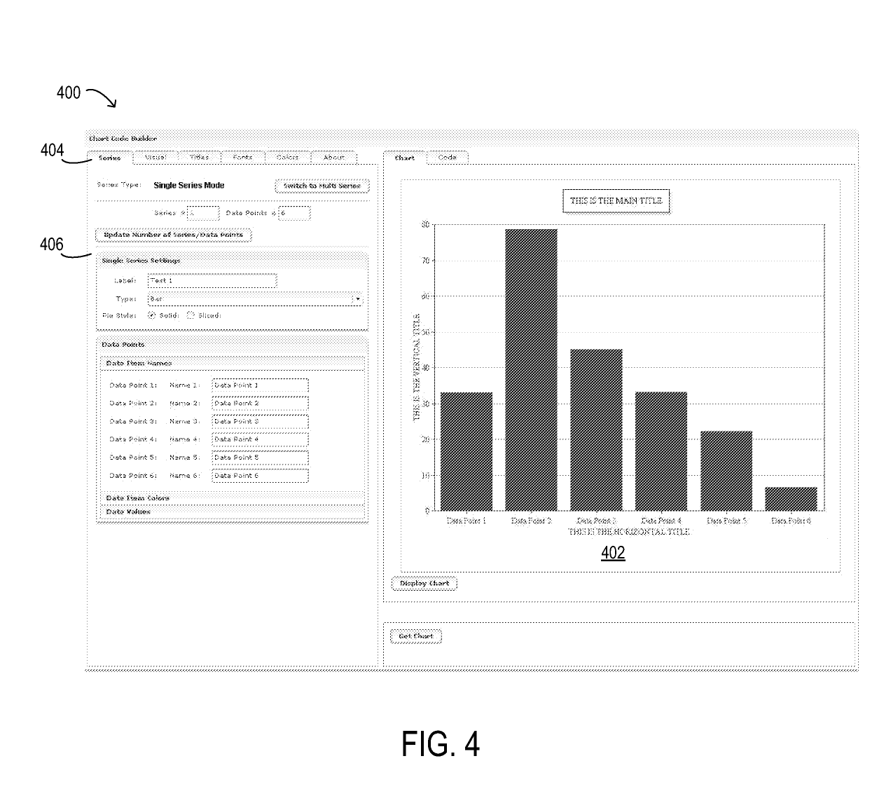

Referring now to FIG. 4, an embodiment of user interface 400 for specifying a statistical operation and a graphical representation of the results of the statistical operation are illustrated. User interface 400 may represent an embodiment of browser-accessible statistical analysis module 116 executable using web browser 114. In user interface 400, selection elements 404 may be used to access various groups of functional elements. For example, a ‘Series’ tab may denote a panel for specifying features of raw data for the statistical operation. As shown in FIG. 4, panel 406 provides various exemplary user input options for specifying and/or selecting the raw data. In FIG. 4, graphical representation 402 may be displayed to show the results of statistical operation, such as a representation of the output data as a series according to the associated range values.

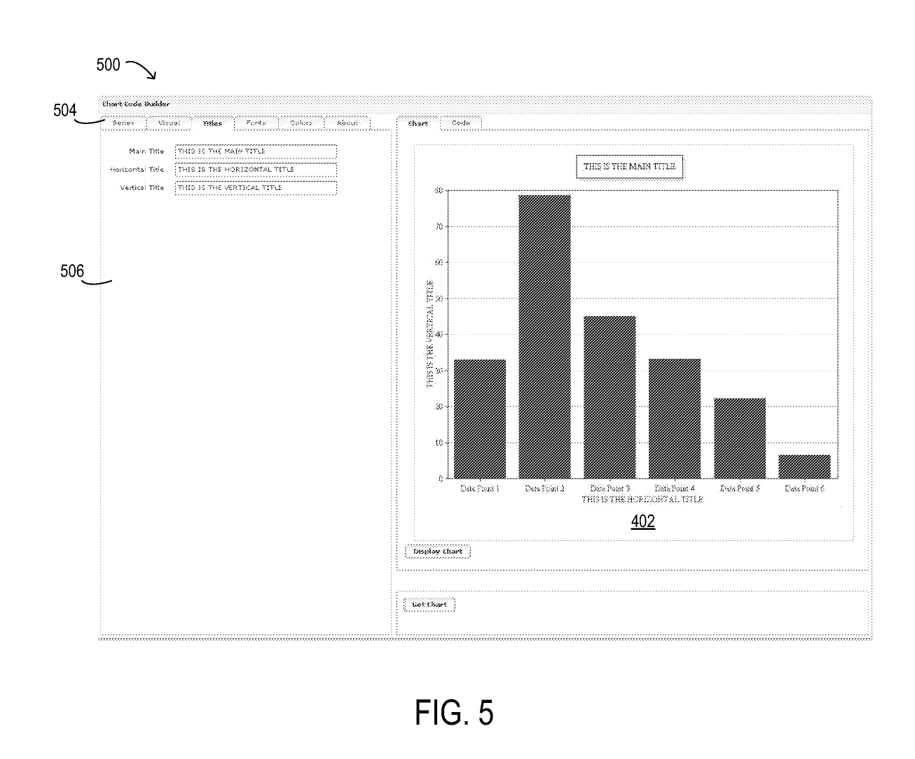

Referring now to FIG. 5, an embodiment of user interface 500 for specifying a statistical operation and a graphical representation of the results of the statistical operation are illustrated. User interface 500 may represent an embodiment of browser-accessible statistical analysis module 116 executable using web browser 114. In user interface 500, selection elements 504 may be used to access various groups of functional elements. For example, a ‘Titles’ tab may be used to access panel 506 providing formatting and labeling options for raw data and associated range values. In FIG. 5, graphical representation 402 may be displayed to show the results of a statistical operation, such as a representation of the output data. Graphical representation 402 may also include the actual formatting and labeling inputs entered in panel 506.

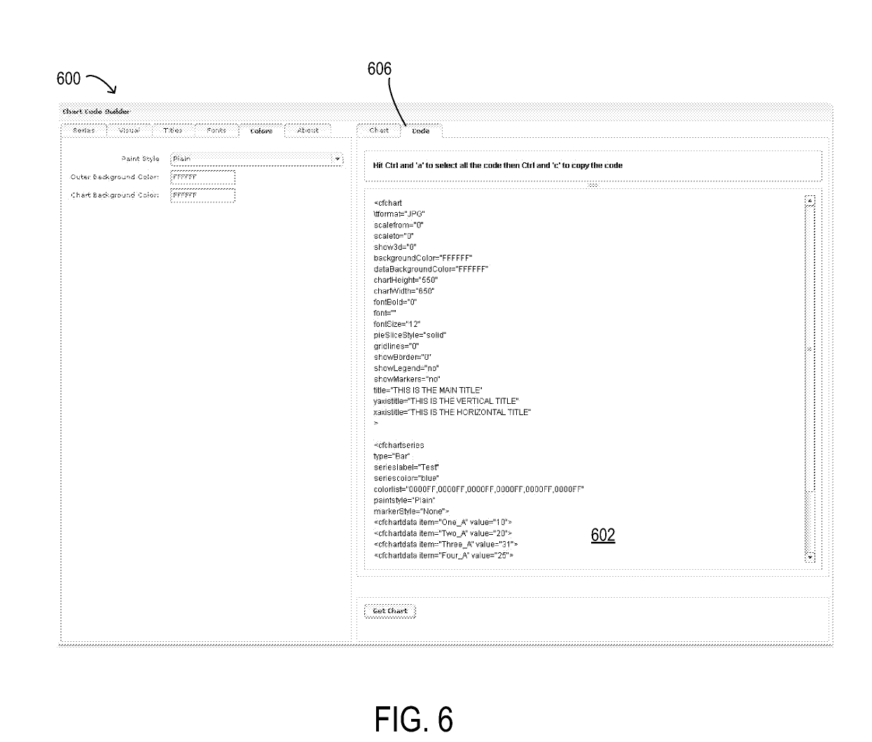

Referring now to FIG. 6, an embodiment of user interface 600 for specifying a statistical operation and a graphical representation of the results of the statistical operation are illustrated. User interface 600 may represent an embodiment of browser-accessible statistical analysis module 116 executable using web browser 114. In user interface 600, selection elements 606 may be used to access various groups of functional elements for outputting a graphical representation. As shown in user interfaces 400 and 500 (see FIGS. 4 and 5), the graphical representation may be displayed. In user interface 600, an alternative output option is shown in panel 602 in the form of program code for generating the graphical representation. It is noted that in alternative embodiments, user interface 600 may include functionality for exporting program code in panel 602 or transmitting the program code to another computer, such as a network server or another web client. It is noted that although FIGS. 4-6 have been depicted with simplistic raw data, the method described herein may be applicable to very large raw data series and complex statistical operations.

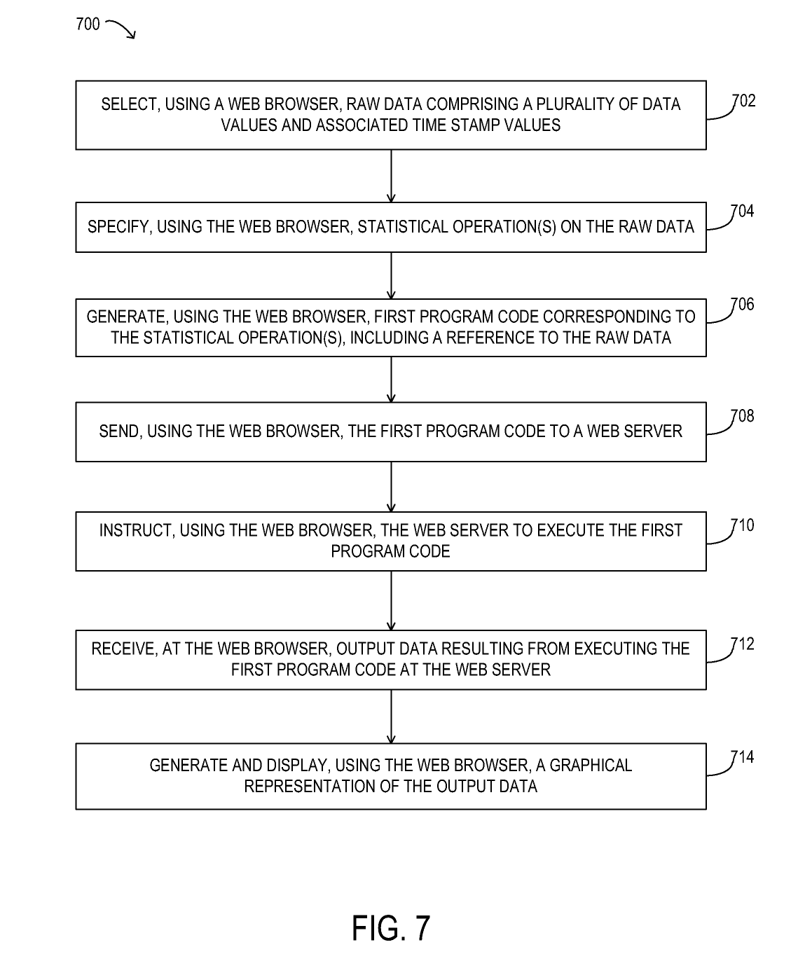

Turning now to FIG. 7, an embodiment of method 700 for performing statistical analysis using a web browser is illustrated. In one embodiment, method 700 is performed by web browser 114 executing on enterprise data processing system 100 (see FIG. 1). Method 700 may also be performed in conjunction with functionality provided by various elements in enterprise network system 200, such as statistical analysis engine 204 (see FIG. 2). It is noted that certain operations described in method 700 may be optional or may be rearranged in different embodiments.

Using a web browser, raw data comprising a plurality of data values and associated time stamp values may be selected (operation 702). Using the web browser, statistical operation(s) on the raw data may be specified (operation 704). Using the web browser, first program code corresponding to the statistical operation(s), including a reference to the raw data, may be generated (operation 706). Using the web browser, the first program code may be sent to a web server (operation 708). Using the web browser, the web server may be instructed to execute the first program code (operation 710). Output data resulting from executing the first program code at the web server may be received at the web browser (operation 712). Using the web browser, a graphical representation of the output data may be generated and displayed (operation 714).

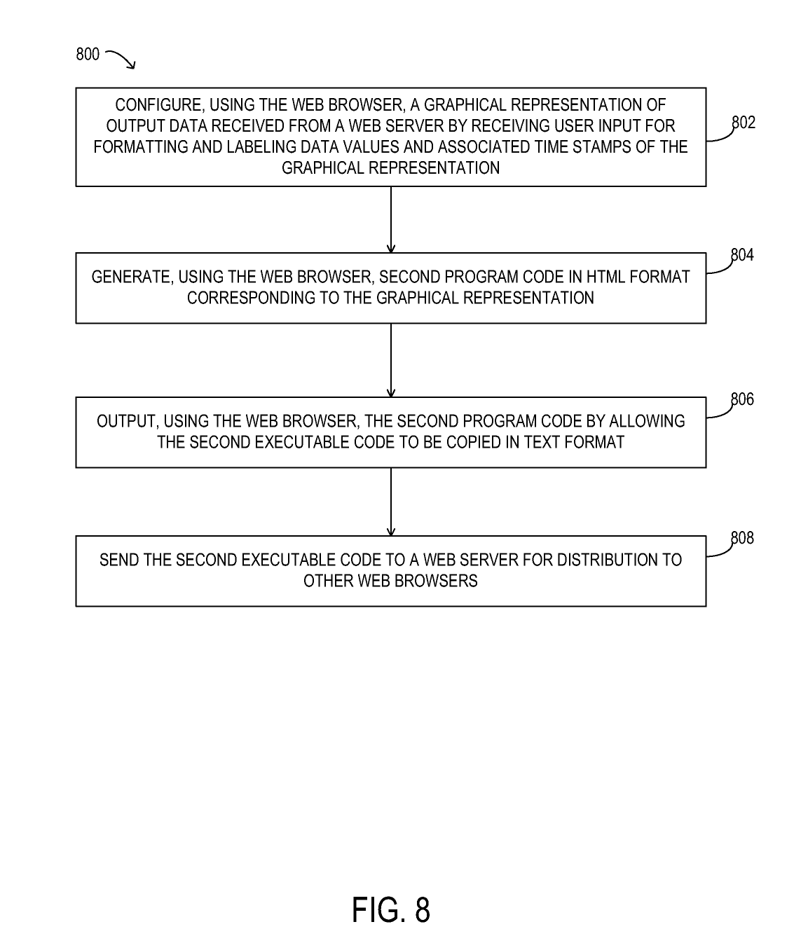

Turning now to FIG. 8, an embodiment of method 800 for performing statistical analysis using a web browser is illustrated. In one embodiment, method 800 is performed by web browser 114 executing on enterprise data processing system 100 (see FIG. 1). Method 800 may also be performed in conjunction with functionality provided by various elements in enterprise network system 200, such as statistical analysis engine 204 (see FIG. 2). It is noted that certain operations described in method 800 may be optional or may be rearranged in different embodiments.

Using the web browser, a graphical representation of output data received from a web server may be configured by receiving user input for formatting and labeling data values and associated time stamps of the graphical representation (operation 802). Using the web browser, second program code in HTML format corresponding to the graphical representation may be generated (operation 804). Using the web browser, the second program code may be output by allowing the second executable code to be copied in text format (operation 806). The second executable code may be sent to a web server for distribution to other web browsers (operation 808).

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method for providing statistical analysis at a web browser, comprising:
selecting, using the web browser, raw data comprising a plurality of data values and associated range values;
specifying, using the web browser, a statistical operation;
causing, using the web browser, the statistical operation to be performed on the raw data; and
receiving, at the web browser, output data resulting from the statistical operations, wherein the output data are usable to generate a graphical representation of a result of the statistical operation.

2. The method of claim 1, wherein said causing further comprises:
sending first program code corresponding to the statistical operations to a network server.

3. The method of claim 2, wherein the network server accesses the raw data via an enterprise database.

4. The method of claim 2, wherein the graphical representation displays the data values as a series according to the associated range values.

5. The method of claim 1, further comprising:
displaying, using the web browser, the graphical representation.

6. The method of claim 5, further comprising:
configuring, using the web browser, the graphical representation, including formatting and labeling of data values and associated range values of the graphical representation.

7. The method of claim 1, further comprising:
generating, using the web browser, second program code corresponding to the graphical representation, wherein the second program code is executable by the web browser to display the graphical representation; and
making the second program code accessible using the web browser.

8. The method of claim 7, wherein the second program code is hypertext markup language code.

9. A computer system for performing statistical analysis at a web browser, comprising:
a processor configured to access a memory medium,
wherein the memory medium includes instructions executable by the processor to:
select, using the web browser, raw data comprising a plurality of data values and associated range values;
specify, using the web browser, a statistical operation on the raw data;
generate, using the web browser, first program code corresponding to the statistical operation, including a reference to the raw data;
send, using the web browser, the first program code to a web server; and
receive, at the web browser, output data resulting from the first program code, wherein the output data are usable to generate a graphical representation of a result of the statistical operation.

10. The computer system of claim 9, wherein the memory medium further comprises processor instructions executable to:
execute the web browser; and
instruct the web server to execute the first program code.

11. The computer system of claim 9, wherein the memory medium further comprises processor instructions executable to:
display, using the web browser, the graphical representation.

12. The computer system of claim 9, wherein the memory medium further comprises processor instructions executable to:
configure, using the web browser, the graphical representation, including receiving user input for formatting and labeling of data values and associated range values of the graphical representation.

13. The computer system of claim 9, wherein the memory medium further comprises processor instructions executable to:
generate, using the web browser, second program code corresponding to the graphical representation, wherein the second program code is executable by the web browser to display the graphical representation; and
output, using the web browser, the second program code.

14. The computer system of claim 13, wherein the second program code is hypertext markup language code.

15. Computer-readable memory media, including instructions for performing statistical analysis at a web browser, said instructions executable to:
select, using the web browser, raw data comprising a plurality of data values and associated range values;
specify, using the web browser, a statistical operation on the raw data;
generate, using the web browser, first program code corresponding to the statistical operation, including a reference to the raw data;
send, using the web browser, the first program code to a web server; and
receive, at the web browser, output data resulting from the first program code, wherein the output data are usable to generate a graphical representation of a result of the statistical operation.

16. The memory media of claim 15, further comprising instructions executable to:
execute the web browser; and
instruct the web server to execute the first program code.

17. The memory media of claim 15, further comprising instructions executable to:
display, using the web browser, the graphical representation.

18. The memory media of claim 15, further comprising instructions executable to:
configure, using the web browser, the graphical representation, including receiving user input for formatting and labeling of data values and associated range values of the graphical representation.

19. The memory media of claim 15, further comprising instructions executable to:
generate, using the web browser, second program code corresponding to the configured graphical representation, wherein the second program code is hypertext markup language code executable by the web browser to display the graphical representation; and
output, using the web browser, the second program code.

20. The memory media of claim 19, further comprising instructions executable to:
send the second executable code to the web server for distribution to other web browsers.
